(19) United States
(12) Patent Application Publication
(10) Pub. No.: US 2002/0047373 A1
(43) Pub. Date: Apr. 25, 2002

(54) Vibrator for vibration therapy and a device for vibration therapy

(76) Inventor: Norbert Schipke, Maxhutte-Haldhof (DE)

Correspondence Address: HOFFMAN WASSON & GITLER, 2361 JEFFERSON DAVIS HIGHWAY, SUITE 522, ARLINGTON, VA, 22202

(21) Appl. No.: 09/941,939

(22) Filed: Aug. 30, 2001

(30) Foreign Application Priority Data
Sep. 2, 2000 (DE) 200 15 190 8
Apr. 28, 2001 (DE) 101 20 981.9

(51) Int. Cl. H02K 7/06

(52) U.S. Cl. 310/81

(57) ABSTRACT

The invention relates to a vibrator for use in devices for vibration therapy, especially for humans. The device has an electric motor and an unbalanced mass, or fly weight, which is driven peripherally by it.

### BACKGROUND OF THE INVENTION

The invention relates to a vibrator and to a device for vibration therapy.

A device for vibration therapy in the form of a backrest for seats, especially office chairs, is known (DE 198 10 755). The vibrator used consists of an electric motor with a rotating shaft on which there is a cam as the unbalance.

The object of the invention is to devise an improved vibrator for devices for vibration therapy.

### SUMMARY OF THE INVENTION

The vibrator is characterized by an especially flat and simple construction and is also suitable for use in backrests in seats, especially automobile seats.

The invention relates to a vibrator for use in devices for vibration therapy, especially for humans. The device has an electric motor and an unbalanced mass, or fly weight, which is driven peripherally by it.

### BRIEF DESCRIPTION OF THE DRAWINGS

The invention is detailed below using the following figures:

FIG. 1 shows, in a simplified representation, a section through the backrest of a seat, for example, a motor vehicle seat, together with a vibrator as claimed in the invention; and

FIG. 2 shows, in a simplified representation, a bathtub with a vibrator located on the bottom of the tub.

### DETAILED DESCRIPTION OF THE INVENTION

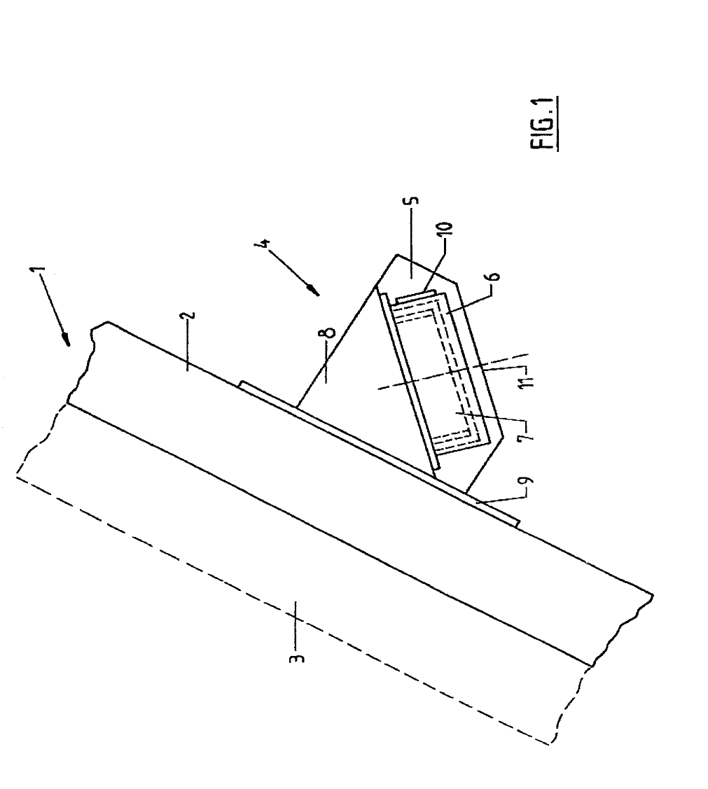

In FIG. 1, the backrest of a seat, for example of a motor vehicle seat, is labelled 1. The backrest 1 consists of a frame or a hard shell 2 on which there is conventional upholstery 3 at least on the front side facing the seat. The vibrator, which is generally labelled 4 in FIG. 1, is attached vibrator, which is generally labelled 4 in FIG. 1, is attached to the shell 2. The vibrator includes an electric motor 5 which is made as an external-rotor motor, with a rotating, cup-like outer housing 6 and a non-rotating inner stator 7 which also has the windings of the electric motor 5. The stator 7 is attached to a bracket 8 which is held for its part on a vibrator plate 9 and is made such that the axis of the motor 5 includes an angle less than 90°, for example an angle of 45°, with the surface sides of the plate 9. The vibrator 4 is directly attached to the frame 2 with the plate 9, for example by screwing it on. The rotating housing 6 is made with an unbalance mass of flyweight 10 so that when the motor 5 is on, it exerts a multiaxial vibration motion, i.e. a vibration motion in several axes, on the plate 9. The motor 5 and the bracket 8 are held in an outer cover housing 11.

The vibrator 4 is characterized by an especially simple and very flat construction. The vibrator 4 can be attached directly to the frame 2 of the backrest 1 by the upholstery 3 since the upholstery 3 causes the necessary damping of the vibration of the vibrator 4.

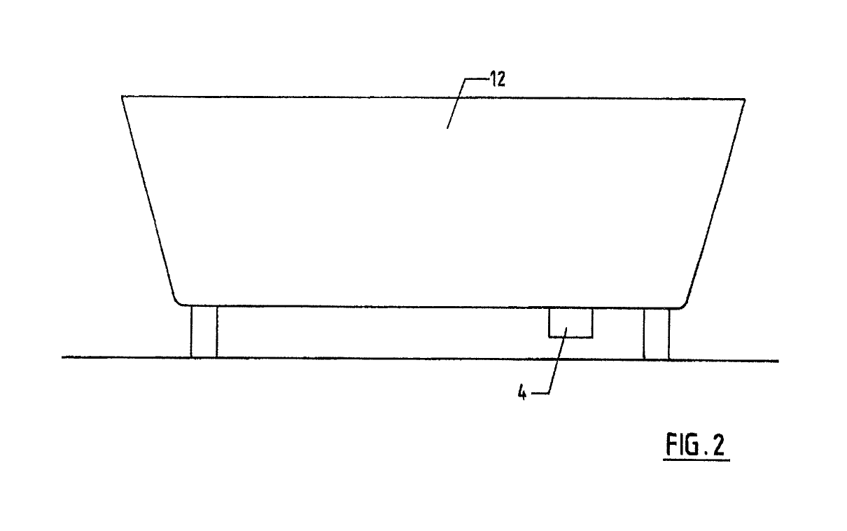

FIG. 2 shows as another possible version, a bathtub 12 which, on the lower side of its bottom, has a vibrator 4 attached there or another vibrator which produces a multiaxial vibration motion and which is formed by an electric motor with a rotating unbalance. The version of FIG. 2 enables intensive application of the vibration motion over a large area to an individual in the bathtub 12 or in the water by the continuation of transmission in the water of the bathtub.

The invention was described above using representative embodiments. It goes without saying that numerous changes and modifications are possible without departing from the inventive idea underlying the invention, and the invention is only limited by the scope of the claims.

Reference Number List

1 backrest

2 frame

3 upholstery

4 vibrator

5 electric motor

6 rotating outer motor housing

7 stator

8 bracket

9 vibrator plate

10 unbalanced mass of flyweight

11 cover

12 bathtub

What is claimed is:

1. A vibrator for use in devices for vibration therapy, the vibrator having an electric motor and an unbalanced mass which is driven peripherally by it, wherein the electric motor is an external-rotor motor with an outer housing which is driven peripherally around a motor axis and with an inner stator which has a motor winding, and wherein the outer housing has the unbalanced mass.

2. The vibrator as claimed in claim 1, wherein the electric motor is attached to a vibrator plate such that the motor axis includes an angle less than 90° with surface sides of the vibrator plate.

3. The vibrator as claimed in claim 2, wherein the electric motor is held in a cover which is connected to the vibrator plate.

4. A device for vibration therapy, comprising at least one vibrator which is provided on a backrest element and which has an electric motor which has an unbalanced mass, wherein the electric motor is an external-rotor motor with an outer housing which is driven peripherally around a motor axis and with an inner stator which has the motor winding, and wherein the outer housing has the unbalanced mass.

5. The device as claimed in claim 4, wherein the at least one vibrator has a vibrator plate attached directly to the back element of a backrest, and wherein the back element has upholstery attached thereto.

6. A device for vibration therapy, comprising at least one vibrator with an electric motor and with an unbalanced mass driven peripherally by it, wherein the device is mounted on an outer surface of a bathtub.

7. The device as claimed in claim 6, wherein the electric motor is made as an external-rotor motor with an outer housing which is driven peripherally around a motor axis and with an inner stator which has a motor winding, and wherein the outer housing has the unbalanced mass.

8. The device as claimed in claim 6, wherein the electric motor is attached to a vibrator plate such that the motor axis includes an angle less than 90° with the surface sides of the vibrator plate.

9. The device as claimed in claim 8, wherein the electric motor is held in a cover which is connected to the vibrator plate.

10. The device as claimed in claim 4, wherein the electric motor is attached to a vibrator plate such that the motor axis includes an angle less than 90° with the surface sides of the vibrator plate.

11. The device as claimed in claim 10, wherein the electric motor is held in a cover which is connected to the vibrator plate.
